(19) United States
(12) Patent Application Publication
(10) Pub. No.: US 2004/0105030 A1
(43) Pub. Date: Jun. 3, 2004

(54) Information processing system, information processing apparatus, information processing method, program storage medium, and program

(76) Inventor: Kenji Yamane, Tokyo (JP)

Correspondence Address: William E. Vaughan, Bell, Boyd & Lloyd LLC, P.O. Box 1135, Chicago, IL, 60690, US

(21) Appl. No.: 10/633,287

(22) Filed: Aug. 1, 2003

(30) Foreign Application Priority Data
Aug. 6, 2002 (JP) JP 2002-228692

(51) Int. Cl. H04N 7/00; H04N 11/00; H04N 7/16; H04N 7/173

(52) U.S. Cl. 348/460; 348/461; 725/135; 725/134; 725/142

(57) ABSTRACT

Personal computers send the IDs of viewed tiles constituting screens viewed by the users to a content server through a packet communication network. The content server replaces specific tiles among the tiles constituting the screen of an image sent from a digital video camera with tiles in another image, and sends the resultant image data to the personal computers through the packet communication network.

The present invention relates to information processing systems, information processing apparatuses, information processing methods, program storage media, and programs, and more particularly, to an information processing system, an information processing apparatus, an information processing method, a program storage medium, and a program which allow images to be dynamically combined in real time easily.

### BACKGROUND OF THE INVENTION

Contents to be streaming distributed in a video-on-demand (VoD) format or a live format are compressed by a method of Moving Picture Experts Group (MPEG) or Joint Photographic Experts Group (JPEG) and further stored, if necessary. In the same way, an image, such as a commercial image, to be combined with a content to be distributed is also compressed. Therefore, when a commercial image is combined with a content to be distributed, they need to be decompressed (decoded) first, combined, and then compressed again.

Since two images need to be decoded, combined by overlay processing or others, and compressed again, which is a troublesome process, combining images requires much time and it is difficult to distribute combined images in real time.

### SUMMARY OF THE INVENTION

The present invention has been made in consideration of such a situation. Accordingly, it is an object of the present invention to allow images to be easily combined in real time.

The foregoing object is achieved in one aspect of the present invention through the provision of an information processing system including a first information processing apparatus for receiving a first content, and a second information processing apparatus for transmitting the first content to the first information processing apparatus, the first information processing apparatus including receiving means for receiving the first content from the second information processing apparatus, and the second information processing apparatus including first acquisition means for acquiring the first content, second acquisition means for acquiring a second content, synthesis means for combining the second content with the first content in units of tiles, and second transmission means for transmitting a resultant content obtained by combining the second content with the first content by the synthesis means, to the first information processing apparatus.

The foregoing object is achieved in another aspect of the present invention through the provision of an information processing method for an information processing system including a first information processing apparatus for receiving a first content and a second information processing apparatus for transmitting the first content to the first information processing apparatus, an information processing method for the first information processing apparatus, including a receiving step of receiving the first content from the second information processing apparatus, and an information processing method for the second information processing apparatus, including a first acquisition step of acquiring the first content, a second acquisition step of acquiring a second content, a synthesis step of combining the second content with the first content in units of tiles, and a second transmission step of transmitting a resultant content obtained by combining the second content with the first content by the process of the synthesis step, to the first information processing apparatus.

The foregoing object is achieved in another aspect of the present invention through the provision of a first information processing apparatus including receiving means for receiving a content from another information processing apparatus, detection means for detecting a tile being displayed, in the content, holding means for holding information of the tile detected by the detection means, and transmission means for transmitting the information of the tile held by the holding means to the another information processing apparatus. The foregoing object is achieved in another aspect of the present invention through the provision of a first information processing method for an information processing apparatus for receiving a content from another information processing apparatus, including a receiving step of receiving a content from the another information processing apparatus, a detection step of detecting a tile being displayed, in the content, a holding step of holding information of the tile detected by the process of the detection step, and a transmission step of transmitting the information of the tile held by the process of the holding step to the another information processing apparatus.

The foregoing object is achieved in another aspect of the present invention through the provision of a first program storage medium having stored therein a computer-readable program for an information processing apparatus for receiving a content from another information processing apparatus, the program including a receiving step of receiving a content from the another information processing apparatus, a detection step of detecting a tile being displayed, in the content, a holding control step of controlling the holding of information of the tile detected by the process of the detection step, and a transmission step of transmitting the information of the tile held by the process of the holding control step to the another information processing apparatus.

The foregoing object is achieved in another aspect of the present invention through the provision of a first program for making a computer for controlling an information processing apparatus for receiving a content from another information processing apparatus execute a receiving step of receiving a content from the another information processing apparatus, a detection step of detecting a tile being displayed, in the content, a holding control step of controlling the holding of information of the tile detected by the process of the detection step, and a transmission step of transmitting the information of the tile held by the process of the holding control step to the another information processing apparatus.

The foregoing object is achieved in another aspect of the present invention through the provision of a second information processing apparatus including first acquisition means for acquiring a first content, second acquisition means for acquiring a second content, synthesis means for combining the second content with the first content in units of tiles, and transmission means for transmitting a resultant content obtained by combining the second content with the first content in units of tiles by the synthesis means, to another information processing apparatus.

The information processing apparatus may be configured such that it further includes receiving means for receiving information of a tile being displayed by the another information processing apparatus, from the another information processing apparatus, and selection means for selecting the second content to be combined with the first content, according to the information of the tile, received by the receiving means, and the synthesis means combines the second content selected by the selection means with the first content.

The information processing apparatus may be configured such that it further includes holding means for holding information of a specific tile specified in advance among tiles, and the synthesis means replaces a part of the first content, corresponding to the specific tile with the second content.

The information processing apparatus may be configured such that it further includes calculating means for calculating the popularity of the specific tile according to the information of the tile, and the selection means selects the second content according to the popularity.

The foregoing object is achieved in another aspect of the present invention through the provision of a second information processing method for an information processing apparatus for transmitting a content to another information processing apparatus, including a first acquisition step of acquiring a first content, a second acquisition step of acquiring a second content, a synthesis step of combining the second content with the first content in units of tiles, and a transmission step of transmitting a resultant content obtained by combining the second content with the first content in units of tiles by the process of the synthesis step, to the another information processing apparatus.

The foregoing object is achieved in another aspect of the present invention through the provision of a second program storage medium having stored therein a computer-readable program for an information processing apparatus for transmitting a content to another information processing apparatus, the program including a first acquisition step of acquiring a first content, a second acquisition step of acquiring a second content, a synthesis step of combining the second content with the first content in units of tiles, and a transmission step of transmitting a resultant content obtained by combining the second content with the first content in units of tiles by the process of the synthesis step, to the another information processing apparatus.

The foregoing object is achieved in another aspect of the present invention through the provision of a second program for making a computer for controlling an information processing apparatus for transmitting a content to another information processing apparatus execute a first acquisition step of acquiring a first content, a second acquisition step of acquiring a second content, a synthesis step of combining the second content with the first content in units of tiles, and a transmission step of transmitting a resultant content obtained by combining the second content with the first content in units of tiles by the process of the synthesis step, to the another information processing apparatus.

In the first information processing apparatus, the first information processing method, the first program storage medium, and the first program according to the present invention, a content sent from another information processing apparatus is received, a tile being displayed is detected in the content, and information of the tile is sent to another information processing apparatus.

In the second information processing apparatus, the second information processing method, the second program storage medium, and the second program according to the present invention, a second content is combined with a first content in units of tiles, and a resultant content obtained by combining the second content with the first content is sent to another information processing apparatus.

As described above, according to the present invention, images can be easily combined at real time. In addition, an image to be combined can be easily substituted. Further, a resultant image obtained by synthesis can be positively presented to the users.

Additional features and advantages of the present invention are described in, and will be apparent from, the following Detailed Description of the Invention and the figures.

### BRIEF DESCRIPTION OF THE DRAWINGS

FIG. 1 is a view showing the structure of an image synthesis system according to an embodiment of the present invention.

FIG. 2 is a block diagram showing the internal structure of a personal computer shown in FIG. 1.

FIG. 3 is a block diagram showing the internal structure of a content server shown in FIG. 1.

FIG. 4 is a block diagram showing the structure of a tile-information holding section shown in FIG. 3.

FIG. 5 is a block diagram showing the structure of an image insertion section shown in FIG. 3.

FIG. 6 is a block diagram showing the internal structure of an image server shown in FIG. 1.

FIG. 7 is a block diagram showing the internal structure of a digital video camera shown in FIG. 1.

FIG. 8 is a flowchart describing a process for transmitting tile information.

FIG. 9 is a view showing example image tiles and example viewed tiles.

FIG. 10 is a view showing an example structure of a packet.

FIG. 11 is a flowchart describing a process for storing tile information.

FIG. 12 is a flowchart describing the processing for storing tile information.

FIG. 13 is a view showing example user-eye-direction information.

FIG. 14 is a view showing example eye-direction tile information.

FIG. 15A is a view showing an update of eye-direction tile information.

FIG. 15B is a view showing an update of user-eye-direction information.

FIG. 16A is a view showing an update of eye-direction tile information.

FIG. 16B is a view showing an update of user-eye-direction information.

FIG. 17A is a view showing an update of eye-direction tile information.

FIG. 17B is a view showing an update of user-eye-direction information.

FIG. 18 is a flowchart describing a process for calculating a specific-tile popularity.

FIG. 19 is a view showing an example specific tile.

FIG. 20 is a view showing example specific-tile-popularity information.

FIG. 21 is a flowchart describing a process for combining images.

FIG. 22 is a flowchart describing the a process for combining images.

FIG. 23 is a view showing the format of encoded image data.

FIG. 24 is a flowchart describing a process for selecting an image.

FIG. 25 is a view showing example data stored in a data base shown in FIG. 6.

FIG. 26 is a view showing example data stored in a tile counter shown in FIG. 6.

FIG. 27 is a view showing an example structure of image data stored in a compressed-image data base shown in FIG. 6.

FIG. 28 is a flowchart describing image display processing.

FIG. 29 is a view showing an example display screen in which combined image data is displayed.

FIG. 30 is a block diagram showing the internal structure of a computer.

### DETAILED DESCRIPTION OF THE INVENTION

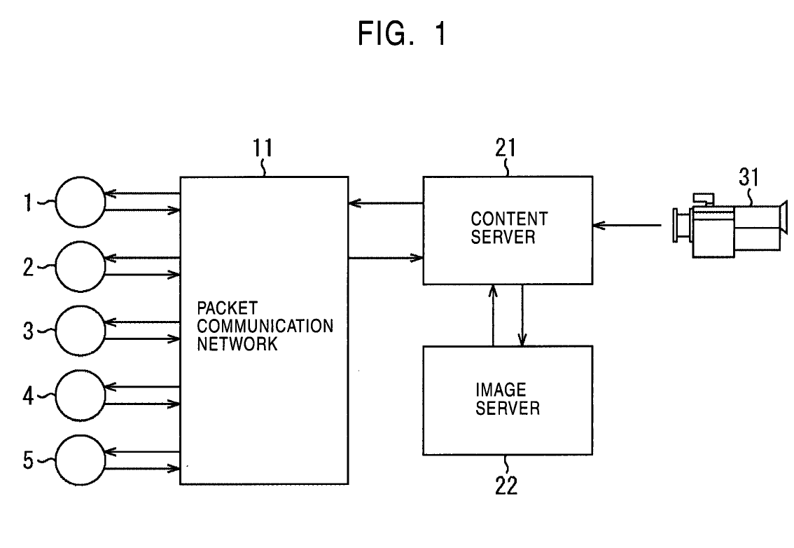

Embodiments of the present invention will be described below by referring to the drawings. FIG. 1 is a view showing an example structure of an image synthesis system according to an embodiment of the present invention.

Personal computers 1 to 5 serving as terminals are connected to a content server 21 through a packet communication network 11, such as the Internet. The content server 21 is connected to a digital video camera 31 and to an image server 22 through a network (including the Internet) not shown.

The personal computers 1 to 5 send user instructions to the content server 21 through the packet communication network 11. The content server 21 reads image data from the digital video camera 31, replaces part of the image data with image data received from the image server 22, and sends the resultant image data to the personal computers 1 to 5 through the packet communication network 11.

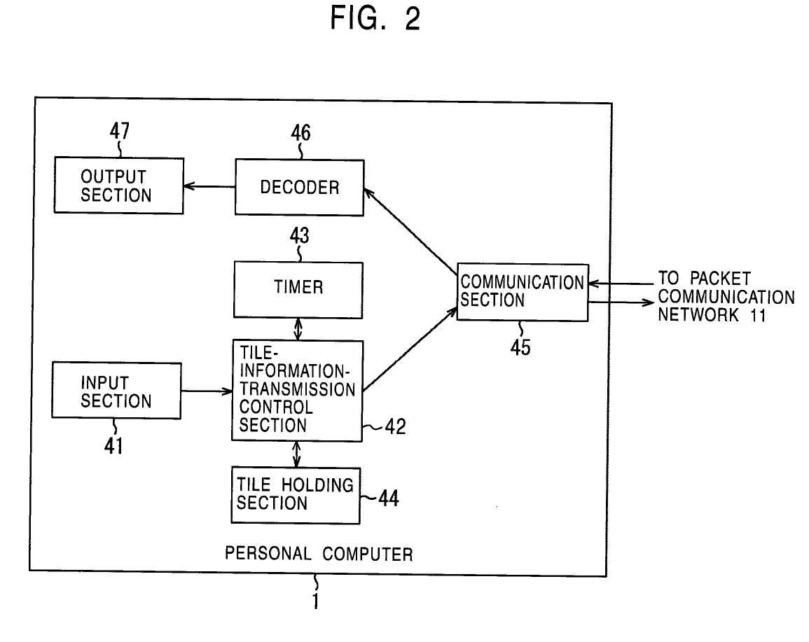

FIG. 2 is a block diagram showing an example structure of the personal computer 1. The input section 41 of the personal computer 1 is connected to a tile-information-transmission control section 42 for controlling the transmission of tile information. The tile-information-transmission control section 42 is connected to a timer 43 for performing time-measuring operations to measure the current time, a transmission time, an elapsed time after transmission, and others, and is also connected to a tile holding section 44 for holding tile information. The tile-information-transmission control section 42 is further connected to a communication section 45 for communication with the content server 21 through the packet communication network 11. The communication section 45 is connected to a decoder 46 for decoding received image data. The decoder 46 is further connected to an output section 47 for outputting decoded image data.

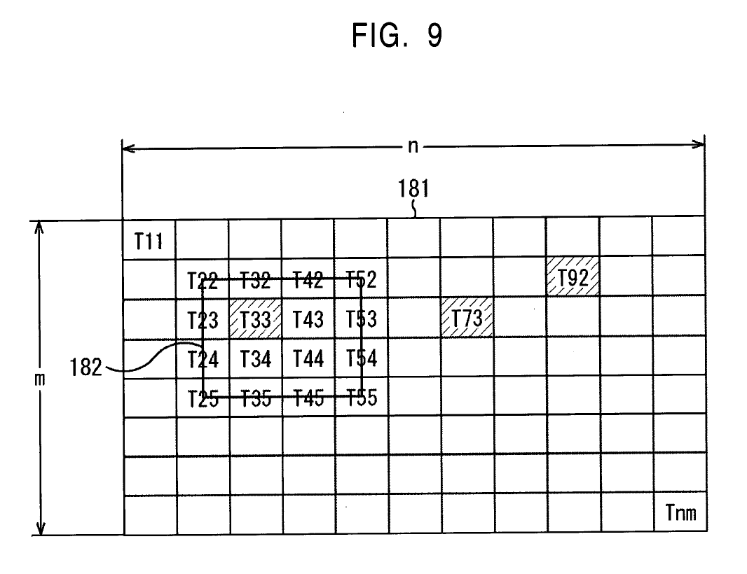

The input section 41 detects the tile IDs (viewed-tile IDs) of tiles (the concept of tiles will be described later by referring to FIG. 9) specifying an area actually presented (displayed) to the user in a one screen content, according to an input from the user, and sends the viewed-tile IDs to the tile-information-transmission control section 42. The tile-information-transmission control section 42 stores the viewed-tile IDs in the tile holding section 44, and writes the viewed-tile IDs stored in the tile holding section 44 into a transmission packet and sends it to the communication section 45. The communication section 45 sends the transmission packet to the content server 21 through the packet communication network 11.

The communication section 45 receives compressed image data (content) from the content server 21 through the packet communication network 11, and sends the image data to the decoder 46. The decoder 46 decodes the image data and outputs to the output section 47. The resultant image is displayed on a display unit or others.

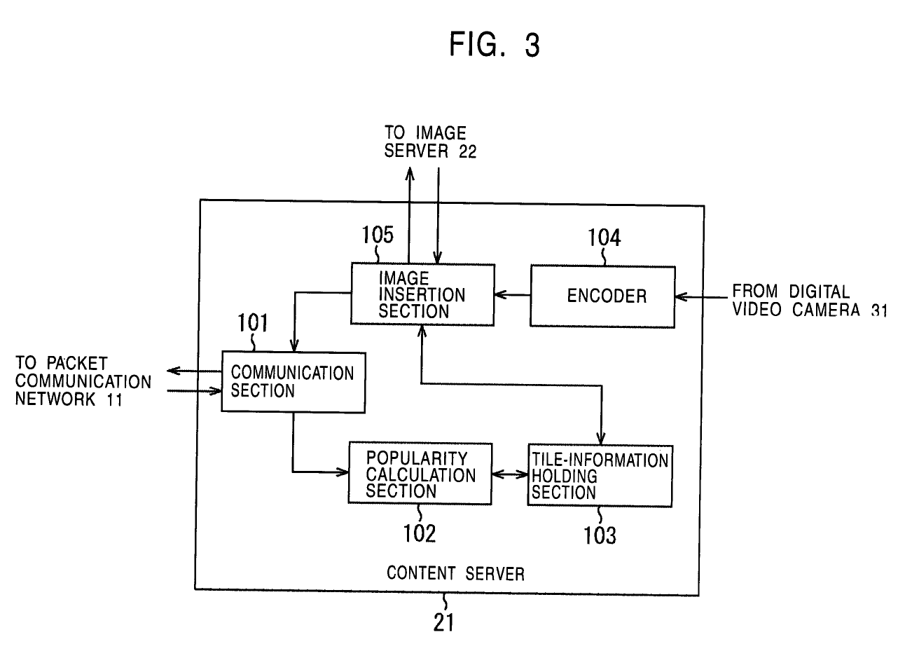

FIG. 3 is a block diagram showing an example structure of the content server 21. A communication section 101 is connected to the personal computer 1 through the packet communication network 11. The communication section 101 is connected to a popularity calculation section 102 for calculating the popularities of tiles. The popularity calculation section 102 is connected to a tile-information holding section 103 for holding the calculated popularities. An encoder 104 encodes image data sent from the digital video camera 31 and is connected to an image insertion section 105.

The encoder 104 receives image data from the digital video camera 31 and encodes the image data. A method capable of tile-division encoding, such as JPEG 2000, is used as a compression method. The encoder 104 encodes the image data, and sends it to the image insertion section 105. The image insertion section 105 is connected to the communication section 101 and to the tile-information holding section 103, and is further connected to the image server 22.

The communication section 101 receives the transmission packet sent from the personal computer 1 through the packet communication network 11, and sends the viewed-tile IDs therein to the popularity calculation section 102. The communication section 101 also sends received image data to the personal computer 1 through the packet communication network 11. The popularity calculation section 102 calculates popularities according to the tile IDs, and stores the popularities in the tile-information holding section 103.

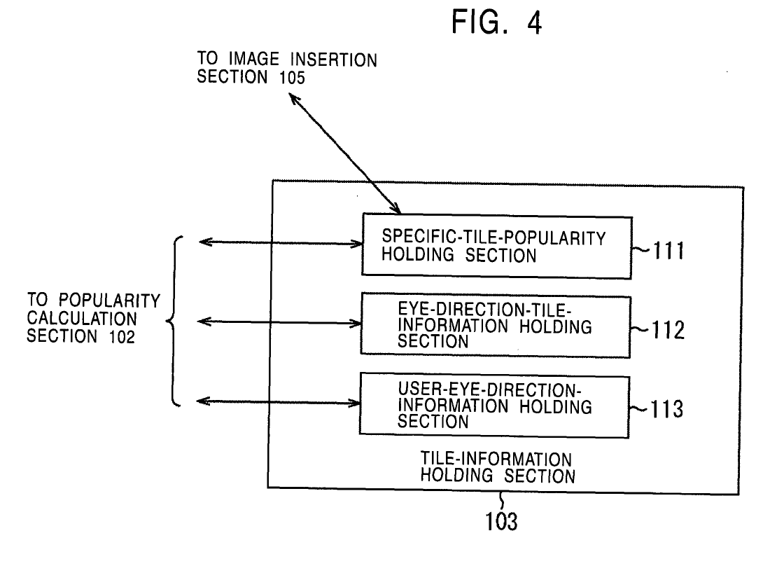

FIG. 4 is a block diagram showing an example structure of the tile-information holding section 103. The tile-information holding section 103 is formed of a specific-tile-popularity holding section 111, an eye-direction-tile-information holding section 112, and a user-eye-direction-information holding section 113. The specific-tile-popularity holding section 111 stores the popularities of specific tile IDs specified in advance by a content creator or others, the popularities being calculated by the popularity calculation section 102. The specific-tile-popularity holding section 111 sends a popularity when the image insertion section 105 requires it.

The eye-direction-tile-information holding section 112 stores information indicating that how many users are viewing predetermined tiles, according to an instruction of the popularity calculation section 102. The user-eye-direction-information holding section 113 stores the viewed-tile IDs of the tiles viewed by each user, according to an instruction of the popularity calculation section 102.

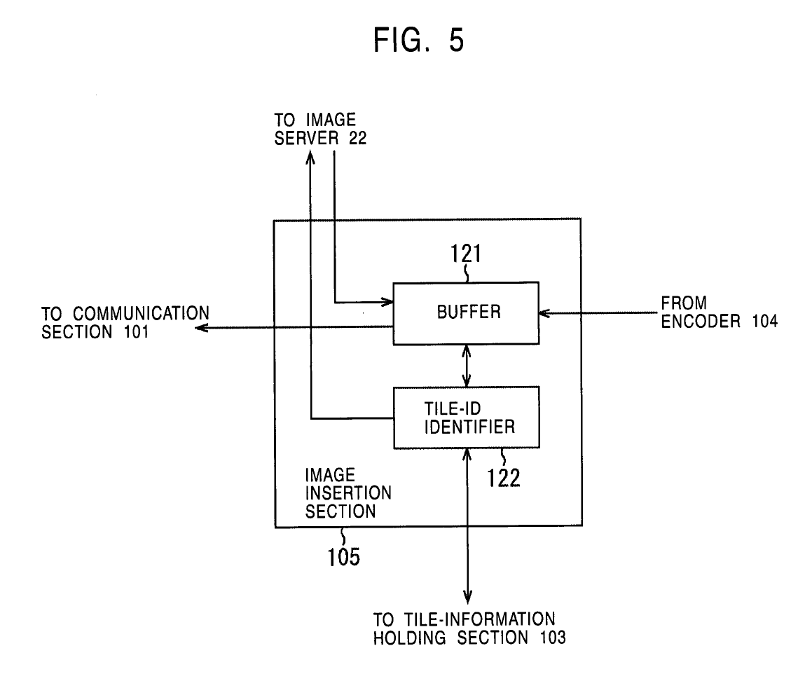

FIG. 5 is a block diagram showing an example structure of the image insertion section 105. The image insertion section 105 is formed of a buffer 121 and a tile-ID identifier 122. The buffer 121 receives one-frame image data from the encoder 104 and holds it. The tile-ID identifier 122 detects specific-tile IDs from the image data. The tile-ID identifier 122 receives information of the specific-tile IDs from the specific-tile-popularity holding section 111. When the tile-ID identifier 122 detects the information corresponding to the specific-tile IDs, the tile-ID identifier 122 sends the information to the image server 22. The buffer 121 receives image data to be substituted for the specific tiles, replaces the stored image data of the specific tiles with the received image data, and sends the resultant image data to the communication section 101.

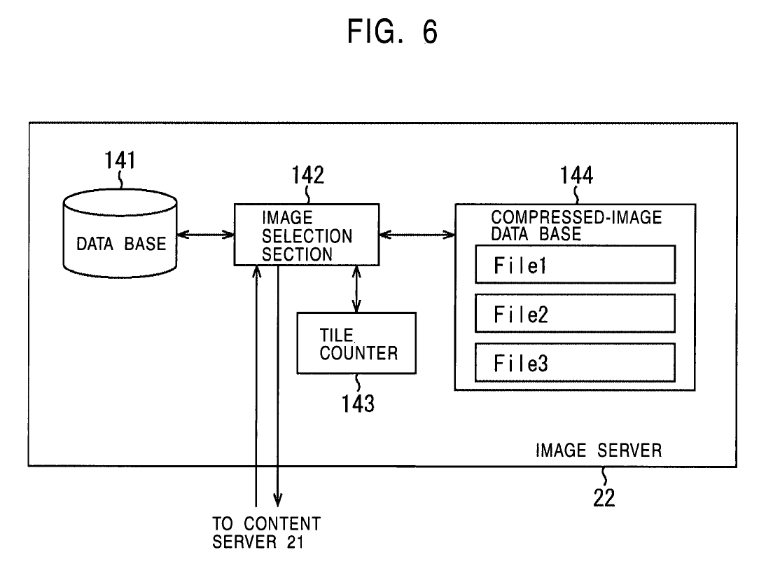

FIG. 6 is a block diagram showing an example structure of the image server 22. An image selection section 142 is connected to a data base 141, a tile counter 143, and a compressed-image data base 144. The image section 142 receives the information of the specific-tile IDs from the content server 21, and selects a file to be substituted, from the data base 141 according to the information.

The image selection section 142 receives the tile counter value corresponding to the selected file, from the tile counter 143. The image selection section 142 receives one-tile image data to be substituted, from the compressed-image data base 144 according to the file name and the tile counter value of the selected file, and sends the image data to the content server 21.

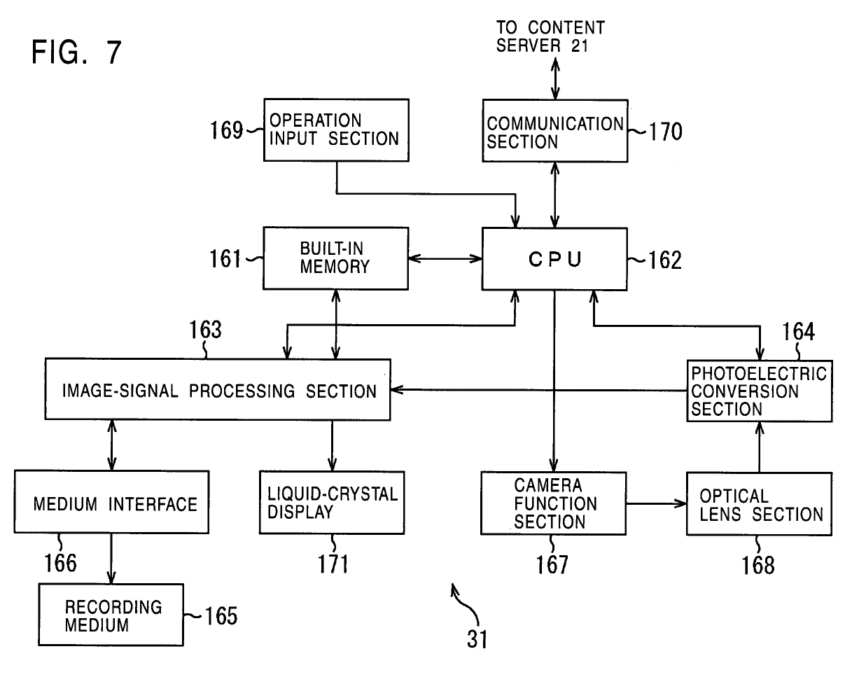

FIG. 7 is a block diagram showing an example structure of the digital video camera 31. The digital video camera 31 has therein a CPU 162 for controlling each section according to user instructions input from an operation input section 169. The CPU 162 is connected to a built-in memory 161. The CPU 162 is connected to an image-signal processing section 163, to a camera function section 167, to a photoelectric conversion section 164 formed of a charge-coupled device (CCD) or a complementary metal-oxide semiconductor (CMOS), and to a communication section 170 for sending data to the content server 21 through networks typical of which is the Internet.

The image-signal processing section 163 is connected to a medium interface 166 for applying data reading and writing interface processing to a recording medium 165 formed of a flash memory or others, and is also connected to a liquid-crystal display 171. Light passing through an optical lens section 168 controlled by the camera function section is incident on the photoelectric conversion section 164.

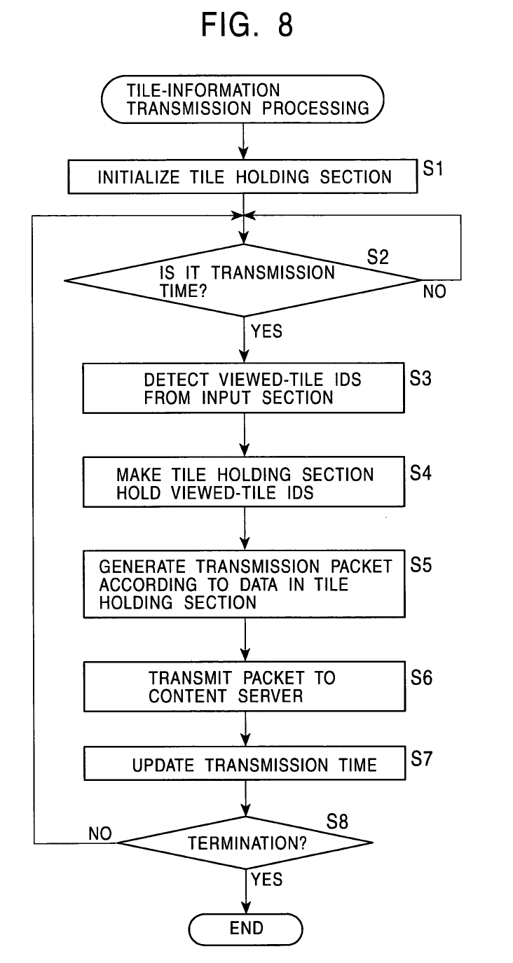

Processing in which the personal computer 1 sends tile information will be described next by referring to a flowchart shown in FIG. 8. In step S1, the tile-information-transmission control section 42 initializes the tile holding section 44. In step S2, the tile-information-transmission control section 42 reads the current time from the timer 43, and determines whether the current time is a transmission time. For example, it is determined whether the current time is equal to or later than a predetermined time specified in advance, after the preceding transmission time stored in a built-in memory. When it is determined that the current time is not a transmission time, the tile-information-transmission control section 42 waits until a transmission time comes.

When it is determined in step S2 that the current time is a transmission time, the processing proceeds to step S3, and the tile-information-transmission control section 42 detects the tile IDs (viewed-tile IDs) of the tiles which the user is viewing, by detecting a user operation at the input section 41 formed of a keyboard or a mouse. Specifically, in this case, the user inputs viewed-tile IDs.

FIG. 9 shows the relationship between image tiles and viewed tiles on a screen output to the display unit of the output section 47 of the personal computer 1. The screen 181 shows a one-frame image captured by the digital video camera 41 and sent from the content server 21 to the personal computer 1. The screen 181 is divided into “nm” tiles having tile IDs of T11 to Tnm. A viewing screen 182 is an area in which the user is actually displaying (viewing) on the display unit, in the screen 181. In this case, the viewing screen 182 shows 16 tiles having tile IDs of T22 to T25, T32 to T35, T42 to T45, and T52 to T55. Therefore, these 16 tile IDs are viewed-tile IDs. The tiles having tile IDs of T33, T73, and T92 are specific tiles specified in advance by the content creator.

In the case shown in FIG. 9, the viewed tiles include tiles of which just part is in the field of vision. Only tiles of which the whole is in the field of vision may be regarded as viewed tiles (then, in the case shown in FIG. 9, only tiles having tile IDs of T33, T34, T43, and T44 are viewed tiles).

When specific tiles are scattered in the screen 181, even if the viewing screen 182 is positioned at any location in the screen 181, the viewing screen 182 always includes a specific tile. Therefore, the image of the specific tile can be positively presented to the user. In addition, an image to be presented can be selected according to the eye direction of the user.

In step S4, the tile-information-transmission control section 42 stores the viewed-tile IDs detected by the process of step S3, in the tile holding section 44. In step S5, the tile-information-transmission control section 42 generates a transmission packet and stores the viewed-tile IDs held by the tile holding section 44, in the data section of the packet.

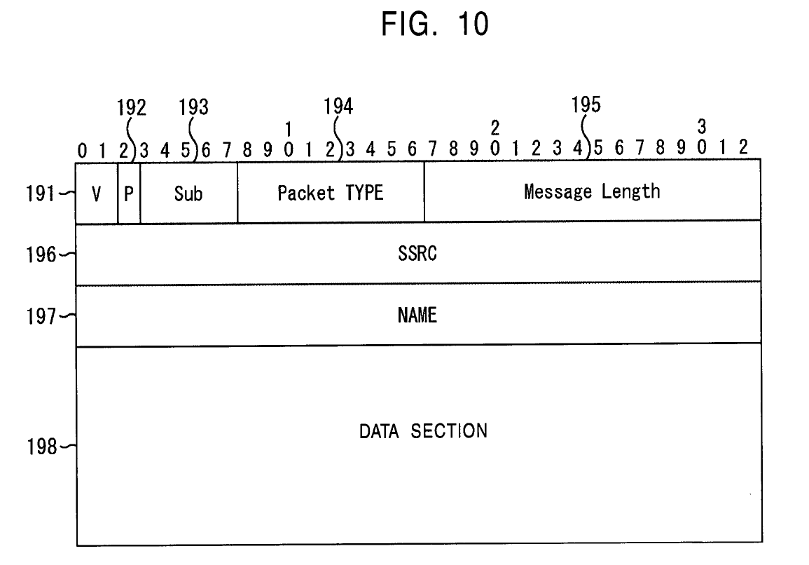

FIG. 10 shows an example format of the transmission packet. The transmission packet conforms to the extension of Application Specific of the real-time transport control protocol (RTCP) defined in RFC 1889. A version number is written in a V field 191, and padding is written in a P field 192. A Sub field 193 indicates a sub type, a Packet TYPE field 194 indicates a packet type, and a Message Length field 195 indicates a message length. A Synchronization Source field (SSRC) 196 shows the identifier (user ID) of a transmission source, a NAME field 197 shows an application name, and a Data section field 198 shows viewed-tile IDs.

In step S6, the tile-information-transmission control section 42 controls the communication section 45 to send the packet to the content server 21 through the packet communication network 11. In step S7, the tile-information-transmission control section 42 reads the current time from the timer 43, and updates the transmission time stored in the built-in memory. In step S8, the tile-information-transmission control section 42 determines whether the user has issued a termination instruction. When it is determined that a termination instruction has not been issued, the processing returns to step S2, and the tile-information-transmission control section 42 repeats the processes of sending viewed-tile IDs until a termination instruction is issued. When it is determined in step S8 that a termination instruction has been issued, the tile-information-transmission control section 42 terminates the processing.

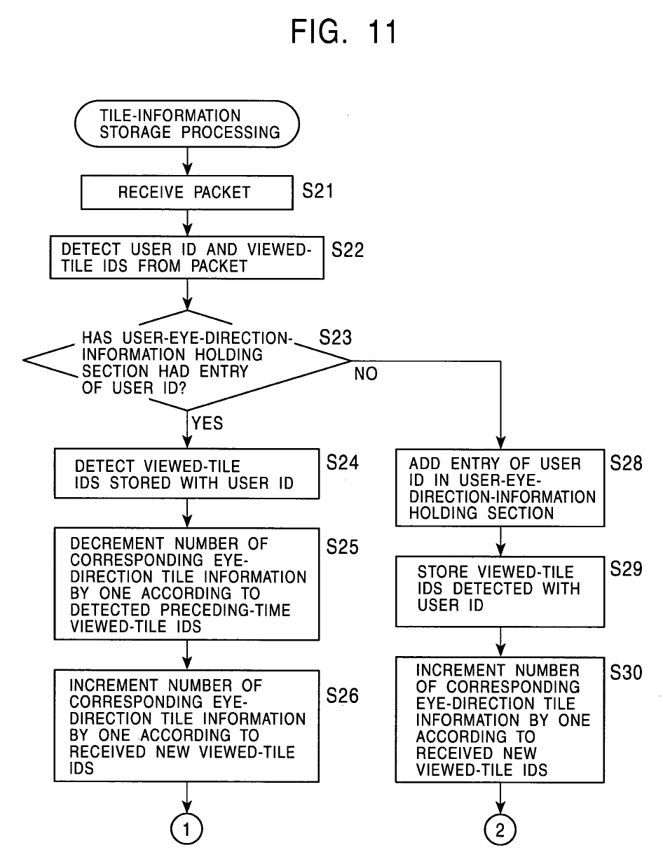

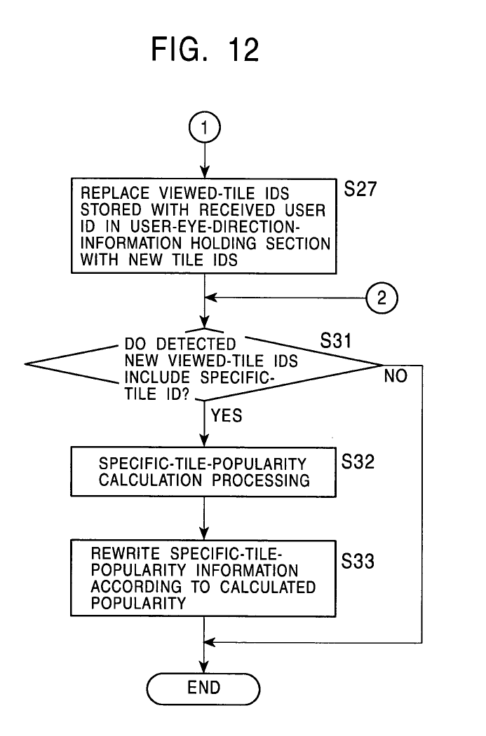

As described above, the personal computer 1 (also each of the personal computers 2 to 5) sends viewed-tile IDs to the content server 21. Processing in which the content server 21 stores tile information according to viewed-tile IDs sent from the personal computer 1 through the packet communication network 11 will be described by referring to FIG. 11 and FIG. 12.

In step S21, the communication section 101 receives the packet sent from the personal computer 1. In step S22, the popularity calculation section 102 detects the user ID and the viewed-tile IDs from the packet received by the communication section 101. Namely, the user ID written in the SSRC field 196 and the viewed-tile IDs written in the Data section field 198 in the packet are detected. In step S23, the popularity calculation section 102 determines whether the user-eye-direction-information holding section 113 (FIG. 4) has had the entry of the detected user ID.

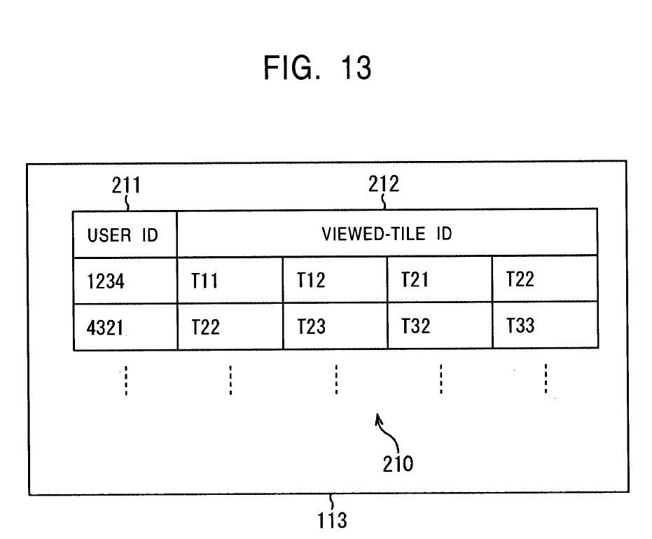

FIG. 13 shows an example of user-eye-direction information 210 stored in the user-eye-direction-information holding section 113. The user-eye-direction-information holding section 113 stores user IDs 211 and the viewed-tile IDs 212 thereof correspondingly.

In the case shown in FIG. 13, a user ID 211 of “1234” corresponds to viewed-tile IDs 212 of “T11, T12, T21, and T22”, and a user ID 211 of “4321” corresponds to viewed-tile IDs 212 of “T22, T23, T32, and T33”.

In step S23, when it is determined that there is the entry of the detected user ID, the processing proceeds to step S24 and the popularity calculation section 102 detects the viewed-tile IDs 212 stored together with the user ID 211 in the user-eye-direction-information holding section 112. For example, in the case shown in FIG. 13, when the detected user ID 211 is “1234”, viewed-tile IDs of “T11, T12, T21, and T22” are detected.

In step S25, the popularity calculation section 102 decrements by one numerals in eye-direction tile information 221 in the eye-direction-tile-information holding section 112, according to the preceding viewed-tile IDs 212 (in this case, viewed-tile IDs of “T11, T12, T21, and T22”) stored in the user-eye-direction-information holding section 113.

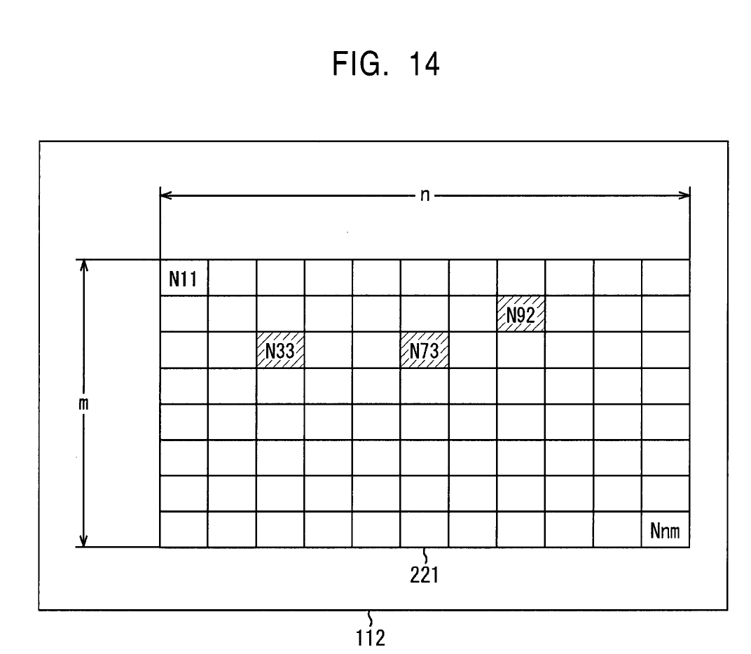

FIG. 14 shows an example of the eye-direction tile information 221 stored in the eye-direction-tile-information holding section 112. The eye-direction tile information 221 stores the number of users (number of tile viewers) who are viewing each of the image tiles having image tile IDs of T11 to Tnm. For example, the number of tile viewers for the tile ID 11 is N11. In other words, the number of tile viewers for the tile having a tile ID of Tnm is Nnm. The numbers of tile viewers N33, N73, and N92 indicate the number of users who are viewing the specific tiles having tile IDs of T33, T73, and T92.

In step S26, the popularity calculation section 102 increments by one the numbers of tile viewers of the eye-direction tile information 221 stored in the eye-direction-tile-information holding section 112, according to the received new viewed-tile IDs. In step S27, the popularity calculation section 102 replaces the viewed-tile IDs 212 stored together with the received user ID 211 in the user-eye-direction-information holding section 113 with the new tile IDs.

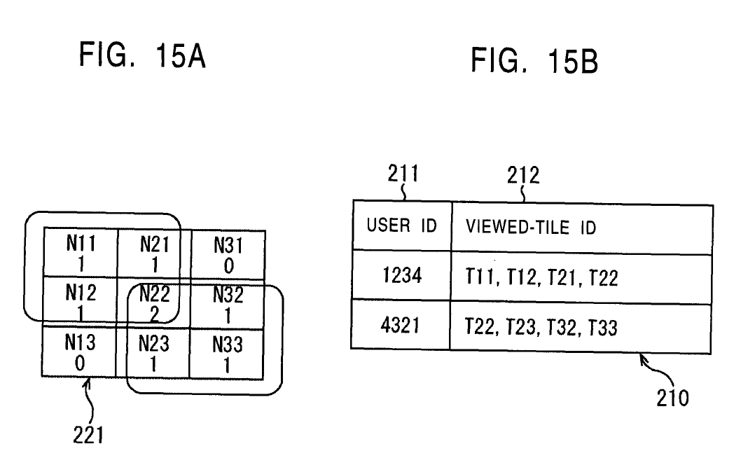

For example, as shown in FIG. 15B, when the user-eye-direction information 210 stores viewed-tile IDs 212 of “T11, T12, T21, and T22” corresponding to a user ID 211 of “1234”, and viewed-tile IDs 212 of “T22, T23, T32, and T33” corresponding to a user ID 211 of “4321”, the numbers N11, N12, N21, N23, N32, and N33 of tile viewers each store “1” in the viewed-tile information 221, as shown in FIG. 15A.

In addition, since the users having user IDs 211 of “1234” and “4321” are viewing the tile having a tile ID of T22, the number N22 of tile viewers stores “2”. Further, since no user is viewing the tiles having tile IDs of T13 and T31, the numbers N13 and N31 of tile viewers store “0”.

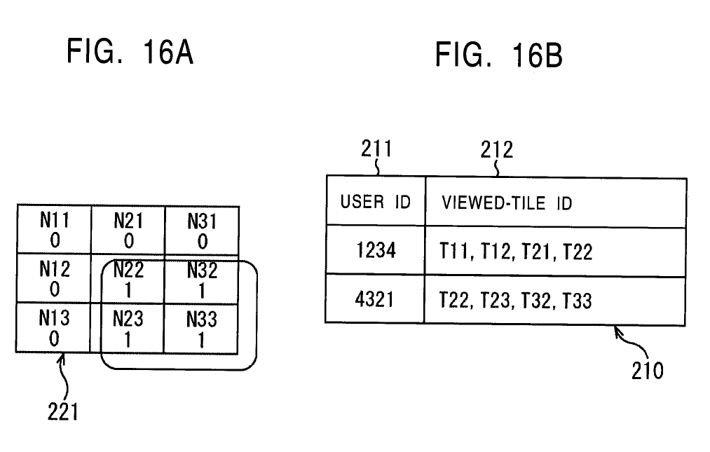

When the new viewed-tile IDs of the user having a user ID 211 of “1234” are detected, the numbers of tile viewers is decremented by one in the viewed-tile information according to the preceding viewed-tile IDs 212 (FIG. 16B), as shown in FIG. 16A. More specifically, since viewed-tile IDs 212 of “T11, T12, T21, and T22” are stored for the user having a user ID 211 of “1234”, only the numbers N11, N12, N21, and N22 of tile viewers are each decremented by one such that the numbers N11, N12, and N21 of tile viewers are changed from “1” to “0” and the number N22 of tile viewers is changed from “2” to “1”.

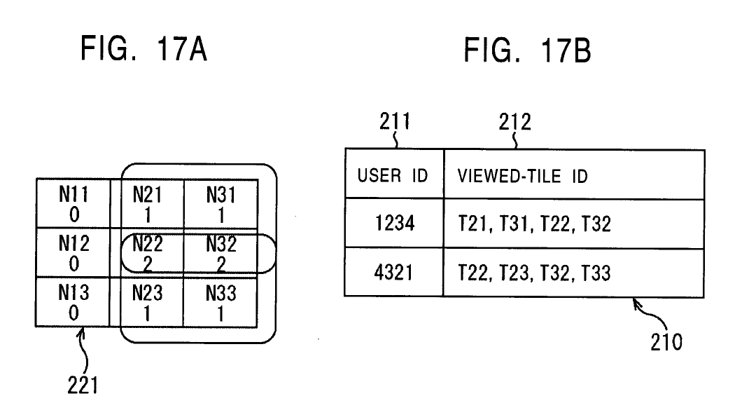

Then, the numbers of tile viewers is incremented by one in the eye-direction tile information 221 according to the detected new viewed-tile IDs (in this case, “T21, T31, T22, and T32” as shown in FIG. 17B), as shown in FIG. 17A. More specifically, the numbers N21 and N31 of tile viewers are changed from “0” to “1” and the numbers N22 and N32 of tile viewers are changed from “1” to “2”. Further, the viewed-tile IDs 212 is changed in the user-eye-direction information 210 such that viewed-tile IDs 212 of “T21, T31, T22, and T32” are stored for the user having a user ID 211 of “1234” (FIG. 17B).

When it is determined in step S23 that there is not the entry of the detected user ID in the user-eye-direction-information holding section 113, the processing proceeds to step S28 and the popularity calculation section 102 adds the detected the entry of the detected user ID to the user IDs 211 in the user-eye-direction information 210.

In step S29, the popularity calculation section 102 stores the detected viewed-tile IDs in the viewed-tile IDs 212 corresponding to the added user ID 211. In step S30, the popularity calculation section 102 increments by one the numbers of tile viewers in the eye-direction tile information 221 according to the detected viewed-tile IDs.

After the process of step S27 or step S30, the processing proceeds to step S31, and the popularity calculation section 102 determines whether the detected new viewed-tile IDs include a specific-tile ID. When it is determined that the detected new viewed-tile IDs include a specific-tile ID, the processing proceeds to step S32, and the popularity calculation section 102 calculates the popularity of a specific tile.

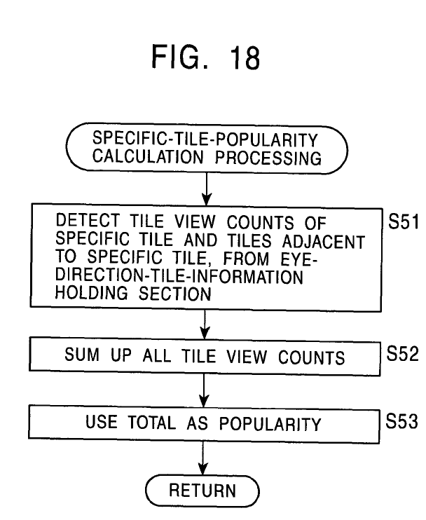

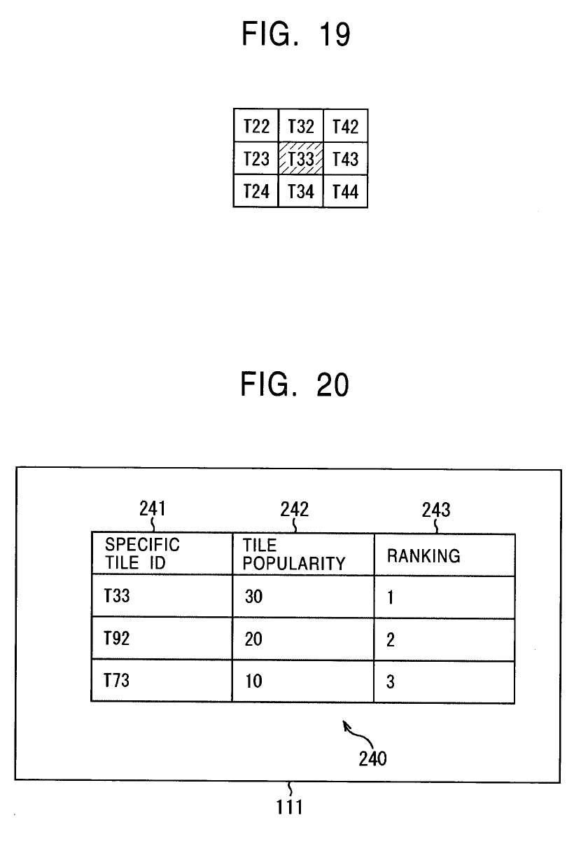

Processing in which the popularity calculation section 102 calculates the popularity of a specific tile will be described by referring to a flowchart shown in FIG. 18. In step S51, the popularity calculation section 102 detects the numbers of tile viewers of specific tiles and tiles adjacent to the specific tiles, in the eye-direction tile information 221 of the eye-direction-tile-information holding section 112. For example, when the viewed-tile IDs include a specific-tile ID of T33, as shown in FIG. 19, the numbers (N22 to N24, N32 to N34, and N42 to N44) of tile viewers for the tiles having tile IDs of T22 to T24, T32 to T34, and T42 to T44 are detected.

In step S52, the popularity calculation section 102 sums up the detected numbers of tile viewers. In step S53, the popularity calculation section 102 sets the popularity of the specific tile to the sum. More specifically, in this case, the popularity of the specific tile T33 is equal to the sum of N22 to N24, N32 to N34, and N42 to N44.

In this case, the popularity is set to the sum of the number of tile viewers of the specific-tile ID and the numbers of tile viewers of the tile IDs adjacent to the specific-tile ID. The popularity may be set to the number of tile viewers of the specific-tile ID.

Back to FIG. 12, in step S33, the popularity calculation section 102 rewrites specific-tile popularity information 240 in the specific-tile-popularity holding section 111 according to the popularity calculated by the process of step S32, and terminates the processing.

FIG. 20 shows an example of the specific-tile popularity information 240. The specific-tile popularity information 240 is formed of a specific-tile ID 241, a tile popularity 242, and a ranking 243. The specific-tile ID 241 stores a specific-tile ID determined in advance by the content creator. The tile popularity 242 stores the popularity calculated by the popularity calculation section 102, correspondingly to the specific-tile ID. The ranking 243 stores numbers starting at “1” according to the descending order of the values in the tile popularity 242. Therefore, the tile popularity 242 and the ranking 243 are updated every time the popularity calculation section 102 calculates the tile popularity. When it is determined in step S31 that the detected new viewed-tile IDs do not include a specific-tile ID, since it is not necessary to calculate a popularity, the popularity calculation section 102 terminates the processing.

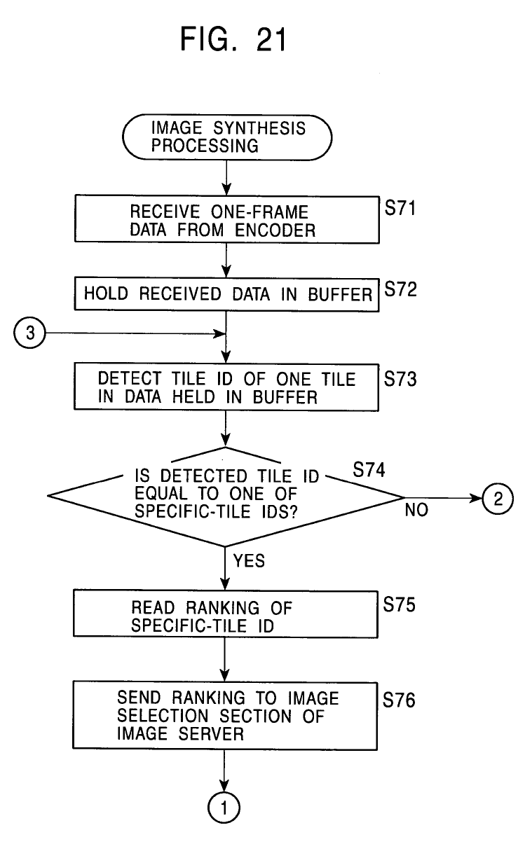

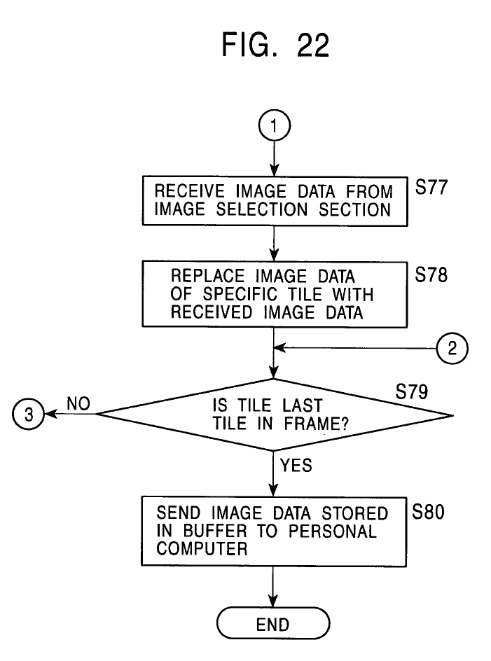

Processing in which the image insertion section 105 combines an image at a specific-tile ID will be described next by referring to a flowchart shown in FIG. 21 and FIG. 22. In step S71, the image insertion section 105 of the content server 21 receives the one-frame image data sent from the digital video camera 31 and encoded by the encoder 104.

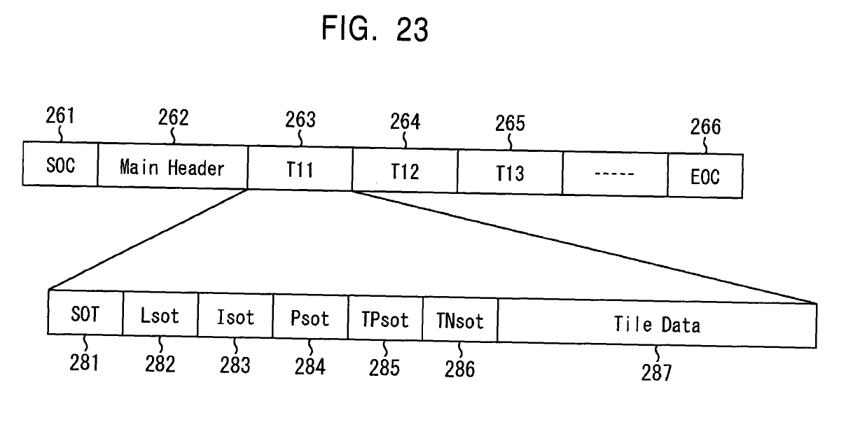

FIG. 23 shows example one-frame data of an image file tile-encoded by the encoder 104 according to JPEG 2000. The one-frame data is formed of a start of code (SOC) 261, a main header 262, a T11 tile 263, a T12 tile 264, a T13 tile 265, . . . , and an end of code (EOC) 266. The SOC 261 indicates the start of code and the EOC 266 indicates the end of code. The main header 262 stores a default code style, a code style component, default quantization, a region of interest (ROI), a default progressive sequence, a quantization component, a condensed packet, a tile length, a packet length, a color definition, and a comment.

The T11 tile 263 is formed of a start of tile (SOT) 281 serving as a marker indicating the start of the tile, Lsot 282 which stores the magnitude of a marker segment, Isot 283 which stores a tile number, Psot 284 which stores the length of the tile, TPsot 285 which stores a tile part number, TNsot 286 which stores a tile part count, and Tile Data 287 which stores the data of the tile. The T12 tile 264, the T13 tile 265, and the other tiles have the same structure as the T11 tile 263.

In step S72, the image insertion section 105 stores the received data in the buffer 121. In step S73, the tile ID identifier 122 detects the tile ID of one tile in the data stored in the buffer 121.

In step S74, the tile ID identifier 122 determines whether the detected tile ID is equal to a specific-tile ID. When it is determined that the detected tile ID is equal to a specific-tile ID, the processing proceeds to step S75, and the ranking of the specific-tile ID is read from the specific-tile-popularity holding section 111 of the tile-information holding section 103.

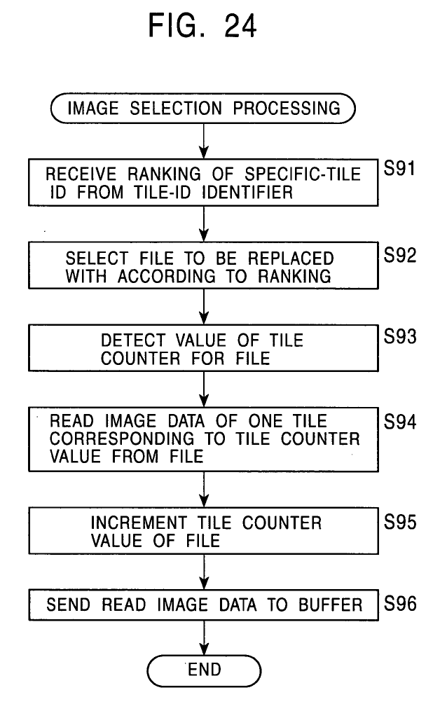

In step S76, the tile ID identifier 122 sends the ranking to the image selection section 142 of the image server 22. Since the image server 22 sends back the image data having the specified ranking (in step S96 of FIG. 24, described later), the buffer 121 receives the image data sent from the image selection section 142, which is to be substituted for the specific tile, in step S77. In step S78, the buffer 121 substitutes the received image data for the stored image data of the specific tile having the specific-tile ID detected by the tile ID identifier 122.

After the process of step S78, or when it is determined in step S74 that the detected tile ID is not equal to a specific-tile ID, the processing proceeds to step S79, and the tile ID identifier 122 determines whether the tile is the last tile in the frame. When it is determined that the tile is not the last tile in the frame, the processing returns to step S73. The tile ID identifier 122 performs a process of detecting the tile ID of the next tile stored in the buffer 121, and substituting data when the tile ID is equal to a specific-tile ID, until the last tile in the frame.

When it is determined in step S79 that the tile is the last tile in the frame, the processing proceeds to step S80, and the buffer 121 controls the communication section 101 to send the stored image data to the personal computer 1 through the packet communication network 11, and terminates the processing.

Processing in which the image server 22 selects an image to be placed at a specific tile will be described next by referring to a flowchart shown in FIG. 24. In step S91, the image selection section 142 receives the ranking (ranking sent by the process of step S76 shown in FIG. 21) of the specific-tile ID from the tile ID identifier 122 of the image insertion section 105. In step S92, the image selection section 142 selects a file to be substituted, according to the ranking by referring to the data base 141.

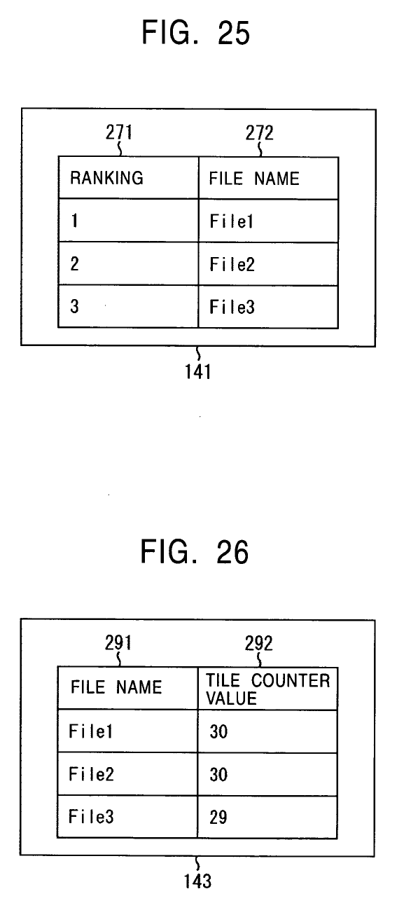

FIG. 25 shows example data stored in the data base 141. The data base 141 stores, correspondingly to popularity rankings 271, the file names 242 of image data to be substituted as specific tiles having the rankings. The relationship between the rankings 271 and the file names 272 are determined in advance by the content creator such that, for example, rankings are assigned to the commercial image files of advertisers in the descending order of the money they have paid for the advertisements.

More specifically, the data having a file name 272 of “File1” is to be substituted, for the specific tile having the first popularity ranking 271, the data having a file name of “File2” is to be substituted, for the specific tile having the second popularity ranking, and the data having a file name of “File3” is to be substituted, for the specific tile having the third popularity ranking. In step S93, the image selection section 142 detects the tile counter value of the file name of the selected file to be substituted, in the tile counter 143.

FIG. 26 shows example tile-counter information stored in the tile counter 143. The tile-counter information stores, correspondingly to file names 291, tile-counter values 292 which specify the tiles to be substituted for next. In the case shown in FIG. 26, the files having file names 291 of “File1” and “File2” correspond to a tile-counter value 292 of “30”, and the file having a file name of “File3” corresponds to a tile-counter value 292 of “29”. The tile-counter values 292 are updated every time the image data of specific tiles are substituted for. In step S94, the image selection section 142 reads the image data of the tile corresponding to the detected tile-counter value, from a file in the compressed-image data base 144.

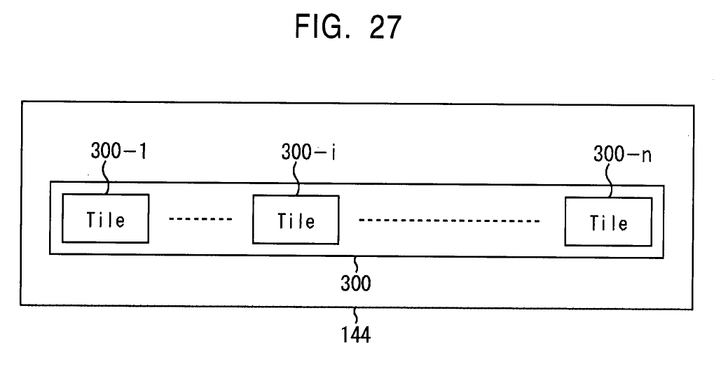

FIG. 27 shows an example file stored in the compressed-image data base 144 and formed of compressed image data. The file 300 is formed of Tile 300-1, Tile 300-2, . . . , and Tile 300-n. Since one tile is combined in one frame, this example file includes images to be combined in n frames. The size of each tile is the same as that of a tile sent from the digital video camera 31 and tile-encoded by the encoder 104.

For example, when the file having a file name 291 of “File1” is selected as a file to be substituted, since the it corresponds to a tile counter value 292 of “30” as shown in FIG. 26, the image data of the 30-th tile (Tile 300-30 in FIG. 27) in the “File1” file is read.

In step S95, the image selection section 142 increments the tile counter value corresponding to the file to be substituted, stored in the tile counter 143. In the current case, the tile counter value 292 corresponding to “File1” is changed from “30” to “31”. Therefore, when the “File1” file is selected as a file to be substituted, next time, the image data of the 31-st tile (Tile 300-31) in the “File1” file is read as tile data.

In step S96, the image selection section 142 sends the image data read from the compressed-image data base 144 to the buffer 121 of the content server 21. As described above, the image data of the tile is substituted for the image data of the specific tile for synthesis (step S78 in FIG. 22).

In JPEG 2000, encoding and decoding are possible in units of tiles. Therefore, very faster encoding (synthesis) is performed than when image data of the whole of one screen (one frame) is encoded.

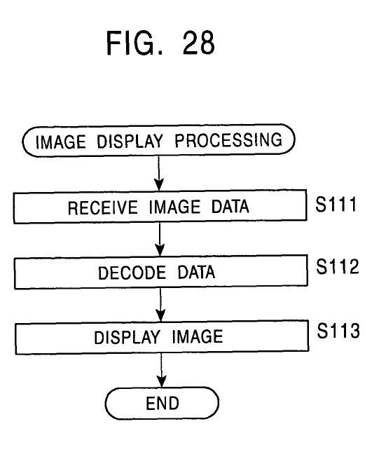

Image display processing in which the output section 47 of the personal computer 1 displays data in which images are combined as described above will be described by referring to a flowchart shown in FIG. 28. In step S111, the communication section 45 of the personal computer 1 receives image data from the content server 21 through the packet communication network 11. In step S1 12, the decoder 46 decodes the received image data. In step S113, the output section 47 displays a decoded image on the display unit or others.

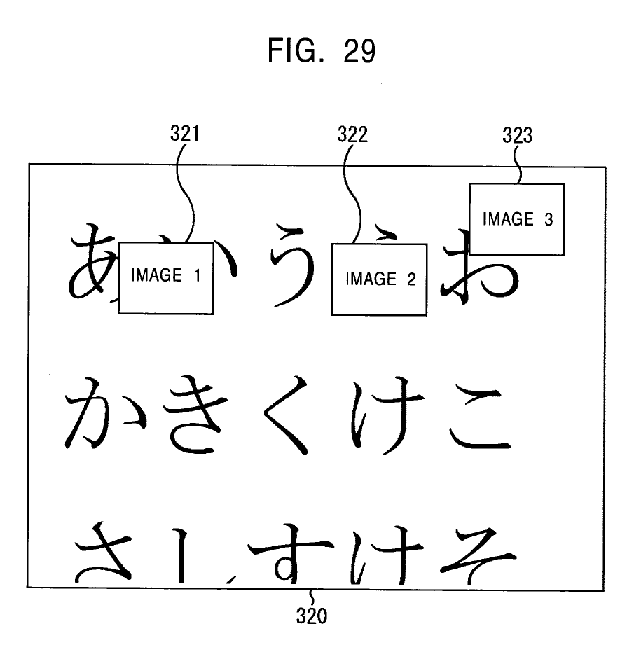

FIG. 29 shows a case in which combined images are displayed on the display unit. An image 321, an image 322, and an image 323, which are part of a screen 320 displayed on the display unit, show specific tiles, and selected images (Tile 300-i in FIG. 27) are combined.

Assuming that image 1, image 2, and image 3 are disposed in that order at tile positions where viewing screens 182 (FIG. 9) having higher popularities are obtained, an advertiser who wants to insert their commercial image in the specific tile where image 1 is disposed needs to pay the highest advertisement charge, and an advertiser who wants to insert their commercial image in the specific tile where image 3 is disposed needs to pay the lowest advertisement charge.

In the case described above, image data stored in the compressed-image data base 144 of the image server 22 is combined with image data sent from the digital video camera 31. In a VoD system, image data recorded in advance in a hard disk or others can be reproduced and a commercial image can be combined with the reproduced image at a predetermined position. In this case, it is necessary that the image insertion section 105 of the content server 21 be connected to a medium, and one-frame data be received from the hard disk instead of the process of step S71 in FIG. 21.

The content server 21 and the image server 22 are separated in the above description. The image server 22 may be integrated into the content server 21 to form a unit. In the above description, the image of each file is substituted for the image at one tile in one frame. The image of each file may be substituted for the image at two or more tiles (the number of tiles should be smaller than the total number of tiles constituting one frame).

In the above processing, combined images are displayed only in the personal computer 1. Actually, the same image data is also distributed to the personal computers 2 to 5 by multicast.

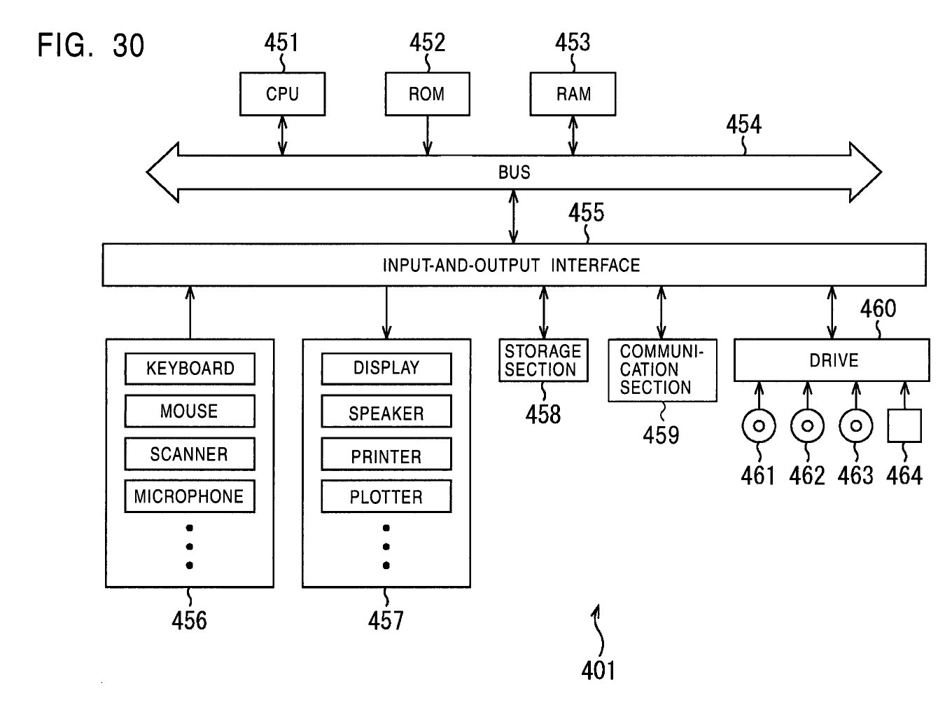

The series of processing described above can be implemented not only by hardware but also by software. In this case, for example, the content server 21 is formed of a computer 401 shown in FIG. 30.

The computer 401 shown in FIG. 30 includes a central processing unit (CPU) 451. The CPU 451 is connected to an input-and-output interface 455 through a bus 454. The bus 454 is connected to a read-only memory (ROM) 452 and to a random access memory (RAM) 453.

The input-and-output interface 455 is connected to an operation input section 456 formed of input devices operated by the user, such as a keyboard, a mouse, a scanner, and a microphone, and to an output section 457 formed of output devices, such as a display, a speaker, a printer, and a plotter. The input-and-output interface 455 is also connected to a storage section 458 formed of a hard disk drive for storing programs and various data, and others, and to a communication section 459 for transmitting and receiving data through networks typical of which is the Internet.

Further, the input-and-output interface 455 is connected, if necessary, to a drive 460 for reading and writing data to and from recording media, such as a magnetic disk 461, an optical disk 462, a magneto-optical disk 463, and a semiconductor memory 464.

An information processing program for making the computer 401 execute the operation of a content server to which the present invention is applied is stored in the magnetic disk 461 (including a floppy disk), the optical disk 462 (including a compact disc read only memory (CD-ROM) and a digital versatile disc (DVD)), the magneto-optical disk 463 (including a Mini disc (MD)), or the semiconductor memory 464, supplied to the computer 401, read by the drive 460, and installed into a hard disk drive built in the storage section 458. The information processing program installed in the storage section 458 is loaded from the storage section 458 to the RAM 453 and executed according to the instruction of the CPU 451 corresponding to a user command input to the input section 456.

When the series of processing is achieved by software, a program constituting the software is installed from recording media or through a network into a computer in which special hardware is incorporated, or into a unit which can executed various functions by installing various programs, such as a general-purpose computer.

The program storage media include not only package media storing the program and distributed separately from the apparatus to provide the program for the users, such as the magnetic disk 461, the optical disk 462, the magneto-optical disk 463, and the semiconductor memory 464, as shown in FIG. 30, but also units which are incorporated in advance in the apparatus and provided for the users, such as the ROM 452 which has stored the program and the hard disk included in the storage section 458.

In the present specification, steps describing the program recorded in a recording medium include not only processing executed in a time-sequential manner in the described order, but also processing which is even not necessarily executed in a time-sequential manner but is processed in parallel or separately.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

What is claimed is:

1. An information processing system comprising:
a first information processing apparatus for receiving a first content; and
a second information processing apparatus for transmitting the first content to the first information processing apparatus;
the first information processing apparatus comprising,
receiving means for receiving the first content from the second information processing apparatus, and
the second information processing apparatus comprising,
first acquisition means for acquiring the first content,
second acquisition means for acquiring a second content,
synthesis means for combining the second content with the first content in units of tiles, and
second transmission means for transmitting a resultant content obtained by combining the second content with the first content by the synthesis means, to the first information processing apparatus.

2. An information processing method for an information processing system comprising a first information processing apparatus for receiving a first content and a second information processing apparatus for transmitting the first content to the first information processing apparatus,
an information processing method for the first information processing apparatus, comprising:
a receiving step of receiving the first content from the second information processing apparatus, and
an information processing method for the second information processing apparatus, comprising:
a first acquisition step of acquiring the first content;
a second acquisition step of acquiring a second content;
a synthesis step of combining the second content with the first content in units of tiles; and
a second transmission step of transmitting a resultant content obtained by combining the second content with the first content by the process of the synthesis step, to the first information processing apparatus.

3. An information processing apparatus comprising:
receiving means for receiving a content from another information processing apparatus;
detection means for detecting a tile being displayed in the content;
holding means for holding information of the tile detected by the detection means; and
transmission means for transmitting the information of the tile held by the holding means to the another information processing apparatus.

4. An information processing method for an information processing apparatus for receiving a content from another information processing apparatus, comprising:
a receiving step of receiving a content from the another information processing apparatus;
a detection step of detecting a tile being displayed in the content;
a holding step of holding information of the tile detected by the process of the detection step; and
a transmission step of transmitting the information of the tile held by the process of the holding step to the another information processing apparatus.

5. A program storage medium having stored therein a computer-readable program for an information processing apparatus for receiving a content from another information processing apparatus, the program comprising:
a receiving step of receiving a content from the another information processing apparatus;
a detection step of detecting a tile being displayed, in the content;
a holding control step of controlling the holding of information of the tile detected by the process of the detection step; and
a transmission step of transmitting the information of the tile held by the process of the holding control step to the another information processing apparatus.

6. A program for making a computer for controlling an information processing apparatus for receiving a content from another information processing apparatus execute:
a receiving step of receiving a content from the another information processing apparatus;
a detection step of detecting a tile being displayed in the content;
a holding control step of controlling the holding of information of the tile detected by the process of the detection step; and
a transmission step of transmitting the information of the tile held by the process of the holding control step to the another information processing apparatus.

7. An information processing apparatus comprising:
first acquisition means for acquiring a first content;
second acquisition means for acquiring a second content;
synthesis means for combining the second content with the first content in units of tiles; and
transmission means for transmitting a resultant content obtained by combining the second content with the first content in units of tiles by the synthesis means, to another information processing apparatus.

8. An information processing apparatus according to claim 7, further comprising:
receiving means for receiving information of a tile being displayed by the another information processing apparatus, from the another information processing apparatus; and
selection means for selecting the second content to be combined with the first content, according to the information of the tile, received by the receiving means,
wherein the synthesis means combines the second content selected by the selection means with the first content.

9. An information processing apparatus according to claim 8, further comprising holding means for holding information of a specific tile specified in advance among tiles,
wherein the synthesis means replaces a part of the first content, corresponding to the specific tile with the second content.

10. An information processing apparatus according to claim 9, further comprising calculating means for calculating the popularity of the specific tile according to the information of the tile,
wherein the selection means selects the second content according to the popularity.

11. An information processing method for an information processing apparatus for transmitting a content to another information processing apparatus, comprising:
a first acquisition step of acquiring a first content;
a second acquisition step of acquiring a second content;
a synthesis step of combining the second content with the first content in units of tiles; and
a transmission step of transmitting a resultant content obtained by combining the second content with the first content in units of tiles by the process of the synthesis step, to the another information processing apparatus.

12. A program storage medium having stored therein a computer-readable program for an information processing apparatus for transmitting a content to another information processing apparatus, the program comprising:
a first acquisition step of acquiring a first content;
a second acquisition step of acquiring a second content;
a synthesis step of combining the second content with the first content in units of tiles; and
a transmission step of transmitting a resultant content obtained by combining the second content with the first content in units of tiles by the process of the synthesis step, to the another information processing apparatus.

13. A program for making a computer for controlling an information processing apparatus for transmitting a content to another information processing apparatus execute:
a first acquisition step of acquiring a first content;
a second acquisition step of acquiring a second content;
a synthesis step of combining the second content with the first content in units of tiles; and
a transmission step of transmitting a resultant content obtained by combining the second content with the first content in units of tiles by the process of the synthesis step, to the another information processing apparatus.
